(19) United States
(12) Patent Application Publication
(10) Pub. No.: US 2026/0342424 A1
(43) Pub. Date: Oct. 29, 2026

(54) METHOD AND APPARATUS FOR BEAM MANAGEMENT

(71) Applicant: 1FINITY Inc., Kawasaki-shi (JP)

(72) Inventors: Guotong WANG, Beijing (CN); Xin WANG, Beijing (CN); Gang SUN, Beijing (CN); Liqiang JIN, Beijing (CN); Qun ZHANG, Beijing (CN)

(73) Assignee: 1FINITY Inc., Kawasaki-shi (JP)

(21) Appl. No.: 19/713,873

(22) Filed: Jun. 19, 2026

Related U.S. Application Data
(63) Continuation of application No. PCT/CN2023/143387, filed on Dec. 29, 2023.

(51) Int. Cl. H04B 7/06; H04L 41/16; H04W 74/0833

(52) U.S. Cl. CPC H04B 7/06964; H04L 41/16; H04W 74/0833

(57) ABSTRACT

An apparatus for beam management includes: a receiver configured to receive beam management configuration information and/or beam failure recovery configuration information from a network device; and processor circuitry configured to determine a candidate beam for beam failure recovery based on an AI/ML functionality/model.

### CROSS-REFERENCE TO RELATED APPLICATION

This application is a continuation application under 35 U.S.C. 111(a) of International Patent PCT/CN2023/143387 filed on Dec. 29, 2023, and designated the U.S., the entire contents of which are incorporated herein by reference.

### TECHNICAL FIELD

Embodiments of the present disclosure relate to the field of communication technologies.

### BACKGROUND

In NR Rel-18, artificial intelligence/machine learning (AI/ML) for an air interface is studied. The AI/ML may be available for the following use cases: channel state information (CSI) feedback enhancement, beam management, and positioning enhancement. The CSI feedback enhancement may include CSI prediction and CSI compression; the beam management may include a spatial beam prediction and a temporal beam prediction; and the positioning enhancement may include direct positioning and AI/ML-assisted positioning.

In some sub-use cases, a bilateral model may be used, i.e., an AI/ML model is at a terminal equipment side and at a network device side. In other sub-use cases, a unilateral model may be used, that is, the AI/ML model is at the terminal equipment side or at the network device side. For beam management, the AI/ML model may be at the terminal equipment side and/or at the network device side.

It should be noted that the above introduction to the background is merely provided for clear and complete explanation of technical solutions of the present disclosure and for easy understanding by those skilled in the art. And it should not be understood that these technical solutions are known to those skilled in the art only because they are described in the background of the present disclosure.

### SUMMARY

The inventors found that a terminal equipment and/or a network device is/are able to use an AI/ML functionality/model and predict beams for future time instances according to beam measurement results, however, there is currently no definite solution on how to consider beam failure recovery.

In view of at least one of the above problems, embodiments of the present disclosure provide a method and apparatus for beam management.

According to one aspect of the embodiments of the present disclosure, there is provided a method for beam management, including:
receiving, by a terminal equipment, beam management configuration information and/or beam failure recovery configuration information from a network device; and
determining, by the terminal equipment, a candidate beam for beam failure recovery based on an AI/ML functionality/model.

According to another aspect of the embodiments of the present disclosure, there is provided an apparatus for beam management, including:
a receiving unit configured to receive beam management configuration information and/or beam failure recovery configuration information from a network device; and
a processing unit configured to determine a candidate beam for beam failure recovery based on an AI/ML functionality/model.

According to another aspect of the embodiments of the present disclosure, there is provided a method for beam management, including:
transmitting, by a network device, beam management configuration information and/or beam failure recovery configuration information to a terminal equipment;
wherein the terminal equipment determines a candidate beam for beam failure recovery based on an AI/ML functionality/model.

According to another aspect of the embodiments of the present disclosure, there is provided an apparatus for beam management, including:
a transmitting unit configured to transmit beam management configuration information and/or beam failure recovery configuration information to a terminal equipment;
wherein the terminal equipment determines a candidate beam for beam failure recovery based on an AI/ML functionality/model.

According to another aspect of the embodiments of the present disclosure, there is provided a communication system, including:
a network device configured to transmit beam management configuration information and/or beam failure recovery configuration information to a terminal equipment; and
the terminal equipment configured to determine a candidate beam for beam failure recovery based on an AI/ML functionality/model.

One of advantageous effects of the embodiments of the present disclosure is that a terminal equipment determines a candidate beam for beam failure recovery based on an AI/ML functionality/model, and AI/ML is able to be used for new candidate beam identification for beam failure recovery, therefore, accuracy and reliability of the beam failure recovery are improved.

With reference to the following description and drawings, the particular embodiments of the present disclosure are disclosed in detail, and the manners in which the principle of the present disclosure may be used are indicated. It should be understood that the scope of the embodiments of the present disclosure is not limited thereto. The embodiments of the present disclosure contain a plurality of alternations, amendments and equivalents within the scope of the terms of the appended claims.

Features that are described and/or illustrated with respect to one embodiment may be used in a same way or in a similar way in one or more other embodiments, in combination with or instead of the features of the other embodiments.

It should be emphasized that the term "comprise/include" when used herein refers to the presence of features, integers, steps or components, but does not preclude the presence or addition of one or more other features, integers, steps or components.

### BRIEF DESCRIPTION OF THE DRAWINGS

Elements and features depicted in one drawing or embodiment of the present disclosure may be combined with elements and features depicted in one or more additional drawings or embodiments. Moreover, in the drawings, similar reference numerals designate corresponding parts throughout multiple drawings and may be used to designate like or similar parts in more than one embodiment.

FIG. 1 is a schematic diagram illustrating a communication system according to embodiments of the present disclosure;

FIG. 2 is a schematic diagram illustrating a method for beam management according to embodiments of the present disclosure;

FIG. 3 is another schematic diagram illustrating the method for beam management according to embodiments of the present disclosure;

FIG. 4 is another schematic diagram illustrating the method for beam management according to embodiments of the present disclosure;

FIG. 5 is another schematic diagram illustrating the method for beam management according to embodiments of the present disclosure;

FIG. 6 is another schematic diagram illustrating the method for beam management according to embodiments of the present disclosure;

FIG. 7 is a schematic diagram illustrating an apparatus for beam management according to embodiments of the present disclosure;

FIG. 8 is another schematic diagram illustrating the apparatus for beam management according to embodiments of the present disclosure;

FIG. 9 is a schematic diagram illustrating a terminal equipment according to embodiments of the present disclosure; and

FIG. 10 is a schematic diagram illustrating a network device according to embodiments of the present disclosure.

### DETAILED DESCRIPTION

The above and other features of the present disclosure will be apparent with reference to the following description and drawings. In the description and drawings, particular embodiments of the present disclosure have been disclosed in detail as being indicative of some of the embodiments in which the principles of the present disclosure may be employed, however, it should be understood that the present disclosure is not limited to the embodiments described herein. Rather, the present disclosure includes all amendments, variants and equivalents falling within the scope of the appended claims.

In embodiments of the present disclosure, terms "first", "second", etc. are used to differentiate different elements with respect to names, and do not indicate spatial arrangement or temporal orders of these elements, and these elements should not be limited by these terms. Terms "and/or" includes any one and all combinations of one or more relevantly listed terms. Terms "comprising", "including", "having" refer to presence of stated features, elements, components, or assemblies, but do not exclude presence or addition of one or more other features, elements, components, or assemblies.

In embodiments of the present disclosure, singular forms "a", "the", etc., include plural forms, and should be understood as "a kind of" or "a type of" in a broad sense, but should not be limited to a meaning of "one"; and the term "the" should be understood as including both a singular form and a plural form, except clearly specified otherwise. Furthermore, the term "according to" should be understood as "at least partially according to……", the term "based on" should be understood as "at least partially based on……", except clearly specified otherwise.

In embodiments of the present disclosure, the term "communication network" or "wireless communication network" may refer to a network satisfying any one of communication standards, such as Long Term Evolution (LTE), Long Term Evolution-Advanced (LTE-A), Wideband Code Division Multiple Access (WCDMA), and High-Speed Packet Access (HSPA), etc.

Furthermore, communication between devices in a communication system may be performed according to communication protocols at any stage, which may, for example, include but not limited to the communication protocols: 1G (generation), 2G, 2.5G, 2.75G, 3G, 4G, 4.5G, and 5G, New Radio (NR) and 6G in the future, etc., and/or other communication protocols that are currently known or will be developed in the future.

In embodiments of the present disclosure, the term "network device", for example, refers to a device in a communication system that accesses a terminal equipment to a communication network and provides services for the terminal equipment. The network device may include but not limited to devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), an IAB host, etc. Furthermore, the base station may include a remote radio head (RRH), a remote radio unit (RRU), a relay, or a low-power node (such as a femto, and a pico, etc.). And the term "base station" may include some or all of its functions, and each base station may provide communication coverage for a specific geographic area. And a term "cell" may refer to a base station and/or its coverage area, depending on a context in which the term is used.

In embodiments of the present disclosure, the term "user equipment" (UE) or "terminal equipment or terminal device" (TE) refers to, for example, an equipment accessing to a communication network and receiving network services via a network device. The terminal equipment may be fixed or mobile, and may also be referred to as a mobile station (MS), a terminal, a subscriber station (SS), an access terminal (AT), a station, etc.

The terminal equipment may include but not limited to devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, the terminal equipment may include but not limited to a machine-type communication (MTC) terminal, a vehicle mounted communication terminal, a device to device (D2D) terminal, and a machine to machine (M2M) terminal, etc.

Moreover, the term "network side" or "network device side" refers to a side of a network, which may be a base station or include one or more network devices described above. The term "user side" or "terminal side" or "terminal equipment side" refers to a side of a user or a terminal, which may be a UE, or may include one or more terminal equipments described above. "A device" in this text may refer to a network device, and may also refer to a terminal equipment, except otherwise specified.

Scenarios of embodiments in the present disclosure shall be described below by way of examples. However, the present disclosure is not limited thereto.

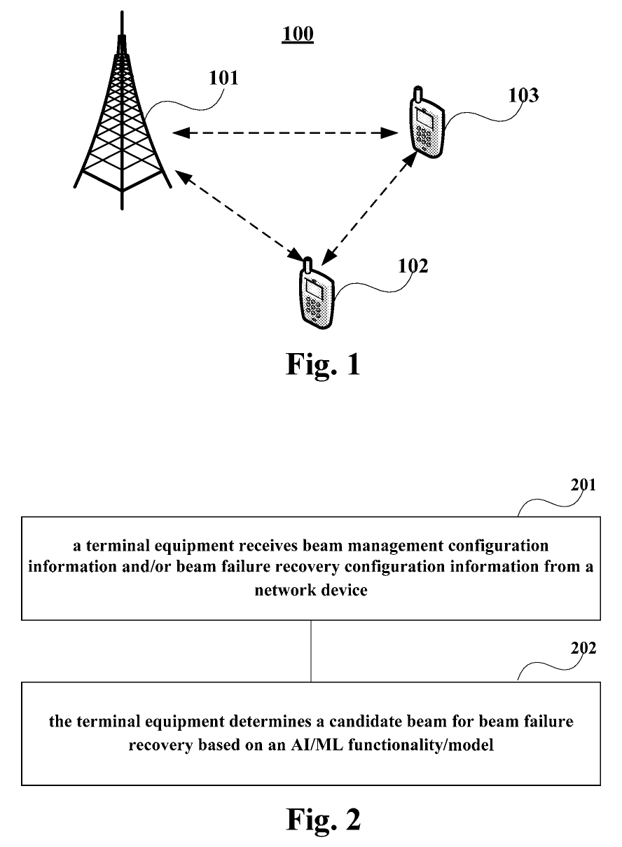

FIG. 1 is a schematic diagram illustrating a communication system according to an embodiment of the present disclosure, which schematically illustrates a situation in which a terminal equipment and a network device are used as an example. As illustrated in the FIG. 1, a communication system 100 may include a network device 101 and terminal equipments 102 and 103. For the sake of simplicity, the FIG. 1 only illustrates two terminal equipments and one network device as an example, however, the embodiments of the present disclosure are not limited thereto.

In embodiments of the present disclosure, existing services or services that may be implemented in the future may be transmitted between the network device 101 and the terminal equipments 102 and 103. For example, these services may include but are not limited to: an enhanced Mobile Broadband (eMBB), a massive Machine Type Communication (mMTC), and an Ultra-Reliable and Low Latency Communication (URLLC), etc.

It should be noted that the FIG. 1 illustrates that both the terminal equipments 102 and 103 fall within coverage of the network device 101, however, the present disclosure is not limited thereto. Both the terminal equipments 102 and 103 may not fall within the coverage of the network device 101, or one terminal equipment 102 falls within the coverage of the network device 101 and the other terminal equipment 103 falls out of the coverage of the network device 101.

In embodiments of the present disclosure, higher layer signaling may be, for example, radio resource control (RRC) signaling; for example, an RRC message, including, for example, a MIB, system information, a dedicated RRC message; or an RRC IE (RRC information element). The higher layer signaling may also be, for example, MAC (Medium Access Control) signaling; or a MAC CE (MAC control element). However, the present disclosure is not limited thereto.

In NR Rel-15, a beam failure recovery operation is introduced. The beam failure recovery operation includes a beam failure detection, a new candidate beam identification, and a beam failure recovery request. For the new candidate beam identification, gNB may configure a candidate beam list for a UE. When a beam failure occurs, the UE selects a candidate beam for communication, and new beam information is transmitted to the gNB via a dedicated physical random access channel (PRACH).

In NR Rel-16, beam failure recovery is extended to a secondary cell (SCell), that is, a beam failure occurs on the SCell, and communication via a primary cell (PCell) may be maintained. In this case, new beam information may be transmitted via a MAC-CE on the PCell.

In embodiments of the present disclosure, one or more AI/ML models may be configured and run in a network device and/or a terminal equipment. The AI/ML model may be used for various signal processing functions of wireless communications, such as CSI prediction, CSI compression, beam prediction, positioning management, etc. The present disclosure is not limited thereto.

### Embodiments of a First Aspect

Embodiments of the present disclosure provide a method for beam management described from a terminal equipment side.

FIG. 2 is a schematic diagram illustrating a method for beam management according to embodiments of the present disclosure. As illustrated in the FIG. 2, the method includes:
201: a terminal equipment receives beam management configuration information and/or beam failure recovery configuration information from a network device; and
202: the terminal equipment determines a candidate beam for beam failure recovery based on an AI/ML functionality/model.

It should be noted that the FIG. 2 only schematically illustrates embodiments of the present disclosure, however, the present disclosure is not limited thereto. For example, an order of execution of operations may be appropriately adjusted, and some other operations may be added, or some operations therein may be removed. And appropriate variants may be made by those skilled in the art according to the above content, without being limited to the disclosure illustrated in the FIG. 2.

In some embodiments, functionality refers to an AI/ML feature/feature group enabled by a configuration, in which the configuration is supported based on conditions indicated by a UE capability.

For example, AL/ML functionality may be one or more functionalities, or may be one or more logical models, or may be one or more sub-functionalities, or may be one or more features, or may be one or more feature groups.

For another example, functionality may refer to using AI/ML for a spatial beam prediction, or using AI/ML for a temporal beam prediction, or using AI/ML for CSI prediction, or use of AI/ML for direct positioning, or using AI/ML for assisted positioning, etc.

In some embodiments, beam management configuration information may include configuration information of one or more reference signals for beam management or beam measurement, such as CSI-RS configuration information, etc; and beam failure recovery configuration information may include configuration information of one or more reference signals for beam failure recovery, such as a CSI-RS list for BFR. The present disclosure is not limited thereto. Reference may be made to the related arts for specific configuration information.

In some embodiments, one or more reference signals are used for measurement and a measurement result is input into the AI/ML functionality/model, and another one or more reference signals are used for output of the AI/ML functionality/model for inference.

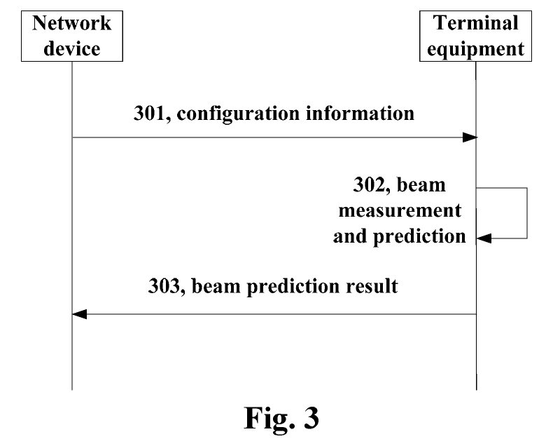

FIG. 3 is another schematic diagram illustrating the method for beam management according to embodiments of the present disclosure described by taking a terminal equipment configured with AI/ML as an example. As illustrated in the FIG. 3, the method includes:
301: a terminal equipment receives configuration information from a network device, for example, the configuration information includes a second reference signal resource set (set B) for beam measurement and a first reference signal resource set (set A) for beam prediction;
302: the terminal equipment performs beam measurement and inputs a result of the beam measurement into an AI/ML functionality/model; for example, the measurement results of the reference signals in the set B are used as an input of AI/ML, and the reference signals in the set A are used for prediction (or inference); and
303: the terminal equipment transmits a beam prediction result to the network device.

For example, an AI/ML functionality is located at a terminal equipment side. After the AI/ML functionality is enabled or activated, the terminal equipment performs beam measurement according to one or more reference signals from a network side, uses AI/ML for beam prediction according to a result of the beam measurement, and transmits the prediction results to the network device.

It should be noted that the FIG. 3 only schematically illustrates the embodiment of the present disclosure, however, the present disclosure is not limited thereto. For example, an order of execution of operations may be appropriately adjusted, and some other operations may be added, or some operations therein may be removed. And appropriate variants may be made by those skilled in the art according to the above content, without being limited to the disclosure illustrated in the FIG. 3.

In some embodiments, candidate beams for beam failure recovery are selected from prediction results output by the AI/ML functionality/model.

For example, an AI/ML functionality/model for a beam prediction (including a spatial beam prediction and/or a temporal beam prediction) may be used for new candidate beam identification in a beam failure recovery operation. One or more reference signals (or a set/list of reference signals) may be used for measurement, and a measurement result is used as an input of AI/ML for beam prediction. Another one or more reference signals (or a set/list of reference signals) may be used for inference, for example, an output of AI/ML for beam prediction.

For example, a new candidate beam may be selected from output of AI/ML for beam prediction. Therefore, as compared with the configured candidate beam reference signal list, the embodiments of the present disclosure are able to improve accuracy and reliability of the beam failure recovery.

In some embodiments, an AI/ML functionality/model for determining the candidate beam is the same as an AI/ML functionality/model for beam management. For example, an AI/ML for beam management and for determining new candidate beam identification in beam failure recovery may be used.

In other embodiments, an AI/ML functionality/model for determining the candidate beam is different from an AI/ML functionality/model for beam management. For example, two AI/MLs may be used, in which one is used for beam management and the other is used to determine new candidate beam identification in beam failure recovery.

In some embodiments, the one or more reference signals for measurement and the one or more reference signals for inference are configured for the terminal equipment.

For example, with AI/ML for new candidate beam identification, the UE may be configured with a reference signal (or a set/list of reference signals) for measurement as an input of the AI/ML and/or a reference signal (or a set/list of reference signals) for AI/ML inference.

In some embodiments, the one or more reference signals for measurement are the same as reference signals in a second reference signal set (set B) for beam management. In some embodiments, the one or more reference signals for measurement are different from reference signals in a second reference signal set (set B) for beam management. In some embodiments, the one or more reference signals for measurement are partially the same as reference signals in a second reference signal set (set B) for beam management. In some embodiments, the one or more reference signals for measurement are a subset of a second reference signal set (set B) for beam management.

For example, reference signals (or a set/list of reference signals) for measurement as an AI/ML input may be the same as/different from/partially overlapped with the reference signals for beam management in the set B, or may be a subset of the reference signals for beam management in the set B.

In some embodiments, the one or more reference signals for inference are the same as reference signals in a first reference signal set (set A) for beam management. In some embodiments, the one or more reference signals for inference are different from reference signals in a first reference signal set (set A) for beam management. In some embodiments, the one or more reference signals for inference are partially the same as reference signals in a first reference signal set (set A) for beam management. In some embodiments, the one or more reference signals for inference are a subset of a first reference signal set (set A) used for beam management.

For example, reference signals (or a set/list of reference signals) for inference may be the same as/different from/partially overlapped with reference signals for beam management in the set A, or may be a subset of reference signals for beam management in the set A.

In some embodiments, the terminal equipment is configured with a candidate beam reference signal list for beam failure recovery. In another embodiment, the terminal equipment is not configured with a candidate beam reference signal list for beam failure recovery.

For example, a new candidate beam RS list is still configured for a UE (for example, if AI/ML for new candidate beam identification is enabled, the new candidate beam RS list is not used by the UE). For another example, the new candidate beam RS list is not configured for the UE.

In some embodiments, the terminal equipment is configured with a candidate beam reference signal list for beam failure recovery, a measurement result of the candidate beam reference signal list is input into the AI/ML functionality/model, and one or more beams in the prediction result output by the AI/ML functionality/model are selected as the candidate beams for beam failure recovery.

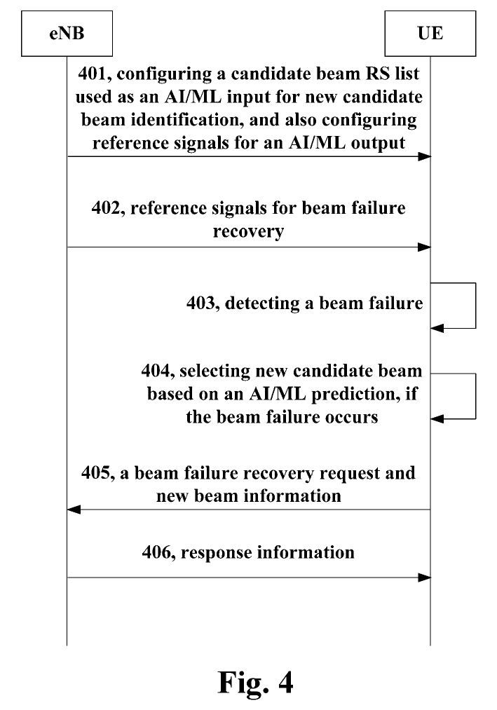

FIG. 4 is another schematic diagram illustrating the method for beam management according to embodiments of the present disclosure. As illustrated in the FIG. 4, the method includes:
401: gNB configures a candidate beam RS list used as an AI/ML input for new candidate beam identification, and the gNB also configures one or more reference signals for an AI/ML output;
: the gNB transmits one or more reference signals for beam failure recovery;
403: a UE detects a beam failure;
404: if the beam failure occurs, the UE selects a new candidate beam based on an AI/ML prediction;
405: the UE transmits a beam failure recovery request and new beam information; and
406: the gNB transmits response information.

It should be noted that the FIG. 4 only schematically illustrates the embodiment of the present disclosure, however, the present disclosure is not limited thereto. For example, an order of execution of operations may be appropriately adjusted, and some other operations may be added, or some operations therein may be removed. And appropriate variants may be made by those skilled in the art according to the above content, without being limited to the disclosure illustrated in the FIG. 4.

In some embodiments, reference signals in the candidate beam reference signal list are the same as reference signals in a second reference signal set (set B) for beam management. In some embodiments, reference signals in the candidate beam reference signal list are different from reference signals in a second reference signal set (set B) for beam management. In some embodiments, reference signals in the candidate beam reference signal list are partially the same as reference signals in a second reference signal set (set B) for beam management. In some embodiments, reference signals in the candidate beam reference signal list are a subset of a second reference signal set (set B) for beam management.

In some embodiments, for example, an RS set for AI/ML inference (output) for new beam identification may be configured separately, for example, the RS set is independent of the set A for beam management. The reference signals in the RS set for AI/ML inference for new beam identification may be the same as/different from/partially overlapped with the reference signals in the set A for beam management, or may be a subset of the reference signals in the set A for beam management. For another example, the RS set for beam management inference (e.g., the set A for beam management) may be used as an RS set for AI/ML inference for new beam identification. For another example, an RS set for inference of new beam identification may be pre-defined/implicitly configured, for example, the set may be all SSB indices.

In some embodiments, the terminal equipment is configured with a candidate beam reference signal list for beam failure recovery, a measurement result of the candidate beam reference signal list is used for inference of the AI/ML functionality/model, and one or more beams in a prediction result output by the AI/ML functionality/model are selected as the candidate beams for beam failure recovery.

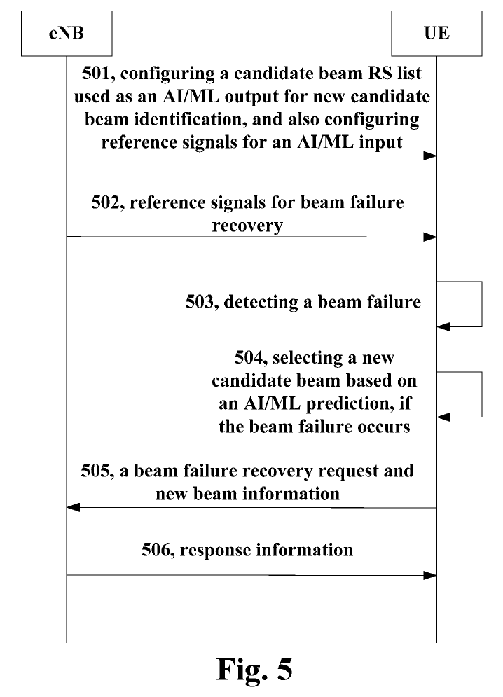

FIG. 5 is another schematic diagram illustrating the method for beam management according to embodiments of the present disclosure. As illustrated in the FIG. 5, the method includes:
501: gNB configures a candidate beam RS list used as an AI/ML output for new candidate beam identification, and the gNB also configures one or more reference signals for an AI/ML input;
502: the gNB transmits one or more reference signals for beam failure recovery;
503: a UE detects a beam failure;
504: if the beam failure occurs, the UE selects a new candidate beam based on an AI/ML prediction;
505: the UE transmits a beam failure recovery request and new beam information; and
506: the gNB transmits response information.

It should be noted that the FIG. 5 only schematically illustrate the embodiment of the present disclosure, however, the present disclosure is not limited thereto. For example, an order of execution of operations may be appropriately adjusted, and some other operations may be added, or some operations therein may be removed. And appropriate variants may be made by those skilled in the art according to the above content, without being limited to the disclosure illustrated in the FIG. 5.

In some embodiments, reference signals in the candidate beam reference signal list are the same as reference signals in a first reference signal set (set A) for beam management, or reference signals in the candidate beam reference signal list are different from reference signals in a first reference signal set (set A) for beam management, or reference signals in the candidate beam reference signal list are partially the same as reference signals in a first reference signal set (set A) for beam management, or reference signals in the candidate beam reference signal list are a subset of a first reference signal set (set A) for beam management.

In some embodiments, for example, an RS set for AI/ML input for new beam identification may be configured separately, for example, the RS set is independent of the set B for beam management. The reference signals in the RS set for AI/ML input for new beam identification may be the same as/different from/partially overlapped with the reference signals in the set B for beam management, or may be a subset of the reference signals in the set B for beam management. For another example, the RS set for beam management input (e.g., the set B for beam management) may be used as an RS set for AI/ML input for new beam identification.

In some embodiments, all reference signals/a part of reference signals/a subset in the set A for beam management are used as new candidate beams. A new candidate beam RS list may still be configured for a UE, or a new candidate beam RS list may not be configured for a UE. In one example, if AI/ML for new candidate beam identification is enabled, the UE does not use the configured new candidate beam RS list.

In some embodiments, all reference signals/a part of reference signals/a subset in the set B for beam management are used as new candidate beams. A new candidate beam RS list may still be configured for a UE, or a new candidate beam RS list may not be configured for the UE. In one example, if AI/ML for new candidate beam identification is enabled, the UE does not use the configured new candidate beam RS list.

In some embodiments, a new candidate beam RS list is configured for a UE. When the UE transmits new beam information to a gNB side, the UE may further indicate whether a new beam is selected from the configured new candidate beam RS list or from the RS set for AI/ML inference of new beam identification.

In some embodiments, the terminal equipment may transmit beam failure recovery information to the network device via at least one of a MAC-CE, a dedicated PRACH, or a contention-based PRACH. The present disclosure is not limited thereto. For example, the above approaches may be combined together, or another approach may be adopted.

For example, new beam information may be transmitted via a MAC-CE. For example, an existing MAC-CE (such as a BFR MAC-CE) may be re-used, or a new MAC-CE may also be introduced. For another example, new beam information may be transmitted via a dedicated PRACH, or via a contention-based PRACH.

In some embodiments, a spatial beam prediction and/or a temporal beam prediction is/are applied to determination of candidate beams for beam failure recovery.

For example, a BM case 1 (spatial beam prediction) and/or a BM case 2 (temporal beam prediction) may be applied to new beam identification in a beam failure recovery operation. For another example, for the temporal beam prediction, if a predicted time instance takes place during beam failure (an interval from beam failure occurrence to beam failure recovery), a predicted beam may be applied to new candidate beam identification.

In some embodiments, the AI/ML functionality/model is also used to predict a beam failure event, wherein L1-RSRP/L1-SINR or hypothetical BLER of one or more reference signals is input into the AI/ML functionality/model.

For example, AI/ML may be used to predict a beam failure event, thereby reducing the workload of beam failure detection and accelerating or avoiding a beam failure recovery operation. For example, if a beam failure event is predicted, the UE may report another candidate beam for communication, such that a beam failure may be reduced. An input of AI/ML for beam failure event prediction may be L1-RSRP/L1-SINR/hypothetical BLER of one or more reference signals.

In some embodiments, the temporal prediction may be applied. For example, the UE may predict quality of a future beam based on historical measurements. In other embodiments, the spatial prediction may also be applied. For example, the UE may predict quality of beams of other CORESETs based on measurements of beams of one or more CORESETs.

The new candidate beam identification in beam failure recovery according to embodiments of the present disclosure is schematically illustrated above. A relationship or interaction between AI/ML-based beam management and beam failure recovery will be further described below. For example, if all (or part) of failed beams are the same as an input/output of AI/ML for beam management, or all (or part) of beams input/output of AI/ML for beam management fail, some interactions occur between beam failure recovery operations and AI/ML-based beam management operations.

In some embodiments, if all input beams of an AI/ML functionality/model for beam management fail, the AI/ML functionality/model for beam management is stopped.

In some embodiments, if all input beams of an AI/ML functionality/model for beam management fail, the AI/ML functionality/model for beam management continues to operate.

In some embodiments, if part of input beams of an AI/ML functionality/model for beam management fails, the failed beams are not input to the AI/ML functionality/model for beam management.

For example, if a subset of input beams of AI/ML for beam management fails, the subset (i.e., the failed beams) should be filtered out from an input of the AI/ML.

In some embodiments, if part of input beams of an AI/ML functionality/model for beam management fails, the failed beams are still input to the AI/ML functionality/model for beam management.

For example, if a subset of input beams of AI/ML for beam management fails, the subset (i.e., the failed beams) still serves as an input of the AI/ML.

In some embodiments, an AI/ML functionality/model for beam management is located at a network device side; if at least part of input beams of the AI/ML functionality/model for beam management fails, the terminal equipment fails to report the failed beams to the network device.

For example, if AI/ML for beam management is at a network side (e.g., a gNB side), when all (or one or more subsets) of input beams of the AI/ML for beam management fail, a UE fails to report the failed beams to the gNB.

In some embodiments, an AI/ML functionality/model for beam management is located at a network device side; if at least part of input beams of the AI/ML functionality/model for beam management fails, the terminal equipment reports the failed beams to the network device.

For example, if AI/ML for beam management is at a network side (e.g., a gNB side), when all (or one or more subsets) of input beams of the AI/ML for beam management fail, a UE still reports the failed beams to the gNB.

In some embodiments, if all output beams of an AI/ML functionality/model for beam management fail, the AI/ML functionality/model for beam management is stopped.

In some embodiments, if all output beams of an AI/ML functionality/model for beam management fail, the AI/ML functionality/model for beam management continues to operate.

In some embodiments, if at least part of output beams (all output beams, or one or more subsets) of an AI/ML functionality/model for beam management fails, the terminal equipment fails to report the failed beams to the network device.

In some embodiments, if at least part of output beams (all output beams, or one or more subsets) of an AI/ML functionality/model for beam management fails, the terminal equipment reports the failed beams to the network device.

In some embodiments, if a beam failure occurs but quality of a failed beam predicted based on an AI/ML functionality/model is still above a threshold, the beam failure is not declared (or not determined).

For example, if a beam failure occurs but quality of the failed beam predicted based on AI/ML is still good, the beam failure is not declared.

In some embodiments, if a beam failure occurs but quality of a failed beam predicted based on an AI/ML functionality/model is still above a threshold, the beam failure is declared (or determined).

For example, if a beam failure occurs but quality of the failed beam predicted based on AI/ML is still good, the beam failure is still declared.

In some embodiments, whether or not a beam failure is declared (or determined) is determined according to a recent event.

For example, whether or not a beam failure is declared depends on a latest event. For example, if a recent event is a beam failure, the beam failure is declared.

In some embodiments, if a candidate beam is determined based on an AI/ML functionality/model for beam management but the candidate beam fails, a terminal equipment falls back to determination of a candidate beam for beam failure recovery without using AI/ML.

For example, if new beam identification is based on AI/ML for beam management, when a predicted beam also fails, a UE needs to fall back to a legacy scheme for new candidate beam identification, e.g., uses a non-AI/ML new candidate beam identification scheme.

Control of an AI/ML functionality/model taking into account a beam failure will be further described below. For example, when an operation of an AI/ML functionality/model for beam management is controlled (e.g., activated/deactivated), a beam failure recovery operation is taken into consideration.

In some embodiments, if a beam failure occurs, an AI/ML functionality/model for beam management is deactivated, and if a beam failure recovery occurs, an AI/ML functionality/model for beam management is activated or re-activated.

For example, after a beam failure occurs, an AI/ML functionality/model for beam management is deactivated. After the beam failure is recovered, the AI/ML functionality/model for beam management may be re-activated via explicit signaling and/or implicit signaling.

In some embodiments, if a beam failure occurs, a first (generalized or default) AI/ML functionality/model for beam management is used, and if a beam failure recovery occurs, a second (local) AI/ML functionality/model for beam management is used.

For example, after a beam failure occurs, an AI/ML functionality/model of beam management may use a generalized model or a default model. After the beam failure is recovered, a local model may be enabled via explicit signaling and/or implicit signaling.

In some embodiments, control of an AI/ML functionality/model for beam management is independent of beam failure recovery.

Performance monitoring of an AI/ML functionality/model taking into account a beam failure will be further described below. For example, when performance monitoring of an AI/ML functionality/model for beam management is performed, a beam failure recovery operation is taken into consideration.

In some embodiments, if a beam failure occurs, performance monitoring of an AI/ML functionality/model for beam management is restarted.

For example, after a beam failure occurs, performance monitoring of an AI/ML functionality/model for beam management is restarted, e.g., a timer/counter is reset and restarted.

In some embodiments, if a beam failure is recovered, performance monitoring of an AI/ML functionality/model for beam management is restarted.

For example, after a beam failure is recovered, performance monitoring of an AI/ML functionality/model for beam management is restarted, e.g., a timer/counter is reset and restarted.

In some embodiments, if a beam failure occurs, performance monitoring of an AI/ML functionality/model for beam management is paused, and if a beam failure is recovered, performance monitoring of an AI/ML functionality/model for beam management is resumed.

For example, after a beam failure occurs, performance monitoring of an AI/ML functionality/model for beam management is paused, and after the beam failure is recovered, the performance monitoring of the AI/ML functionality/model for beam management is resumed. For example, a timer/counter is paused after a beam failure occurs, and resumed after the beam failure is recovered.

In some embodiments, if a beam failure occurs, performance monitoring of an AI/ML functionality/model for beam management is stopped, and if a beam failure is recovered, performance monitoring of an AI/ML functionality/model for beam management is restarted.

For example, after a beam failure occurs, performance monitoring of an AI/ML functionality/model for beam management is stopped, and after the beam failure is recovered, the performance monitoring of the AI/ML functionality/model for beam management is restarted. For example, a timer/counter is stopped after a beam failure occurs, and is reset or restarted after the beam failure is recovered.

In some embodiments, performance monitoring of an AI/ML functionality/model for beam management is independent of beam failure recovery.

In embodiments of the present disclosure, an AI/ML operation may be used for new candidate beam identification in a beam failure recovery operation. Embodiments of the present disclosure define an interaction between AI/ML for beam management and beam failure recovery. In addition, control and performance monitoring of an AI/ML functionality/model taking into consideration of a beam failure are also defined.

Embodiments of the present disclosure may be applied to a terminal equipment side model (UE-side model) and/or a network device side model (gNB-side model). In addition, embodiments of the present disclosure may be applied to a BM case 1 (spatial beam prediction) and/or a BM case 2 (temporal beam prediction).

The above embodiments only illustrate the present disclosure. However, the present disclosure is not limited thereto, and appropriate variants may be made on the basis of the above embodiments. For example, the above embodiments may be used alone, or one or more of the above embodiments may be combined together.

As can be seen from the above embodiments, the terminal equipment determines the candidate beam for beam failure recovery based on the AI/ML functionality/model, and the AI/ML is able to be used for new candidate beam identification for beam failure recovery, therefore, accuracy and reliability of the beam failure recovery are improved.

### Embodiments of a Second Aspect

Embodiments of the present disclosure provide a method for beam management described from a network device side. The embodiments of the second aspect may be combined with the embodiments of the first aspect, and the same contents as those of the embodiments of the first aspect will not be described again.

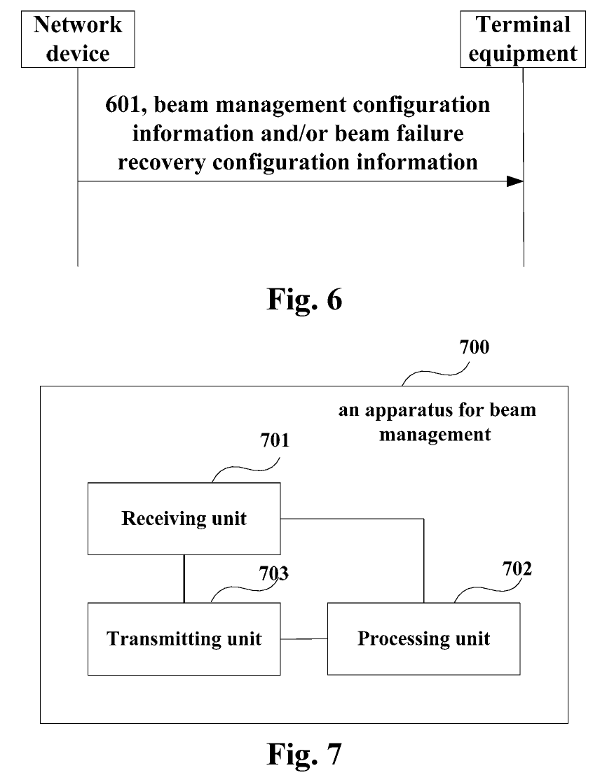

FIG. 6 is another schematic diagram illustrating the method for beam management according to embodiments of the present disclosure. As illustrated in the FIG. 6, the method includes:

601: a network device transmits beam management configuration information and/or beam failure recovery configuration information to a terminal equipment, wherein the terminal equipment determines a candidate beam for beam failure recovery based on an AI/ML functionality/model.

The above embodiments only illustrate the present disclosure. However, the present disclosure is not limited thereto, and appropriate variants may be made on the basis of the above embodiments. For example, the above embodiments may be used alone, or one or more of the above embodiments may be combined together.

As can be seen from the above embodiments, the terminal equipment determines the candidate beam for beam failure recovery based on the AI/ML functionality/model, and the AI/ML is able to be used for new candidate beam identification for beam failure recovery, therefore, accuracy and reliability of the beam failure recovery are improved.

### Embodiments of a Third Aspect

Embodiments of the present disclosure provide an apparatus for beam management, which may be, for example, a terminal equipment, or may be one or more components or assemblies configured in the terminal equipment, and the same contents as those of the embodiments of the first and second aspects will not be described again.

FIG. 7 is a schematic diagram illustrating an apparatus for beam management according to embodiments of the present disclosure. As illustrated in the FIG. 7, an apparatus 700 for beam management according to embodiments of the present disclosure includes:
a receiving unit 701 configured to receive beam management configuration information and/or beam failure recovery configuration information from a network device; and
a processing unit 702 configured to determine a candidate beam for beam failure recovery based on an AI/ML functionality/model.

In some embodiments, one or more reference signals are used for measurement and a measurement result is input into the AI/ML functionality/model, and another one or more reference signals are used for output of the AI/ML functionality/model for inference.

In some embodiments, the candidate beam for beam failure recovery is selected from a prediction result output by the AI/ML functionality/model.

In some embodiments, an AI/ML functionality/model for determining the candidate beam is the same as an AI/ML functionality/model for beam management.

In some embodiments, an AI/ML functionality/model for determining the candidate beam is different from an AI/ML functionality/model for beam management.

In some embodiments, the one or more reference signals for measurement and the one or more reference signals for inference are configured for a terminal equipment.

In some embodiments, the one or more reference signals for measurement are the same as reference signals in a second reference signal set (set B) for beam management.

In some embodiments, the one or more reference signals for measurement are different from reference signals in a second reference signal set (set B) for beam management.

In some embodiments, the one or more reference signals for measurement are partially the same as reference signals in a second reference signal set (set B) for beam management.

In some embodiments, the one or more reference signals for measurement are a subset of a second reference signal set (set B) for beam management.

In some embodiments, the one or more reference signals for inference are the same as reference signals in a first reference signal set (set A) for beam management.

In some embodiments, the one or more reference signals for inference are different from reference signals in a first reference signal set (set A) for beam management.

In some embodiments, the one or more reference signals for inference are partially the same as reference signals in a first reference signal set (set A) for beam management.

In some embodiments, the one or more reference signals for inference are a subset of a first reference signal set (set A) for beam management.

In some embodiments, a terminal equipment is configured with a candidate beam reference signal list for beam failure recovery.

In some embodiments, a terminal equipment is not configured with a candidate beam reference signal list for beam failure recovery.

In some embodiments, a terminal equipment is configured with a candidate beam reference signal list for beam failure recovery, a measurement result of the candidate beam reference signal list is input into the AI/ML functionality/model, and one or more beams in a prediction result output by the AI/ML functionality/model are selected as the candidate beams for beam failure recovery.

In some embodiments, reference signals in the candidate beam reference signal list are the same as reference signals in a second reference signal set (set B) for beam management.

In some embodiments, reference signals in the candidate beam reference signal list are different from reference signals in a second reference signal set (set B) for beam management.

In some embodiments, reference signals in the candidate beam reference signal list are partially the same as reference signals in a second reference signal set (set B) for beam management.

In some embodiments, reference signals in the candidate beam reference signal list are a subset of a second reference signal set (set B) for beam management.

In some embodiments, a terminal equipment is configured with a candidate beam reference signal list for beam failure recovery, a measurement result of the candidate beam reference signal list is used for inference of the AI/ML functionality/model, and one or more beams in a prediction result output by the AI/ML functionality/model are selected as the candidate beams for beam failure recovery.

In some embodiments, reference signals in the candidate beam reference signal list are the same as reference signals in a first reference signal set (set A) for beam management.

In some embodiments, reference signals in the candidate beam reference signal list are different from reference signals in a first reference signal set (set A) for beam management.

In some embodiments, reference signals in the candidate beam reference signal list are partially the same as reference signals in a first reference signal set (set A) for beam management.

In some embodiments, reference signals in the candidate beam reference signal list are a subset of a first reference signal set (set A) for beam management.

In some embodiments, as illustrated in the FIG. 7, the apparatus further includes:
a transmitting unit 703 configured to transmit beam failure recovery information to the network device via at least one of a MAC-CE, a dedicated PRACH, or a contention-based PRACH.

In some embodiments, a spatial beam prediction and/or a temporal beam prediction is/are applied to determination of a candidate beam for beam failure recovery.

In some embodiments, the AI/ML functionality/model is further used to predict a beam failure event, wherein L1-RSRP/L1-SINR or hypothetical BLER of one or more reference signals is input into the AI/ML functionality/model.

In some embodiments, if all input beams of an AI/ML functionality/model for beam management fail, the AI/ML functionality/model for beam management is stopped.

In some embodiments, if all input beams of an AI/ML functionality/model for beam management fail, the AI/ML functionality/model for beam management continues to operate.

In some embodiments, if part of input beams of an AI/ML functionality/model for beam management fails, the failed beams are not input to the AI/ML functionality/model for beam management.

In some embodiments, if part of input beams of an AI/ML functionality/model for beam management fails, the failed beams are still input to the AI/ML functionality/model for beam management.

In some embodiments, an AI/ML functionality/model for beam management is located at a network device side.

If at least part of input beams of the AI/ML functionality/model for beam management fails, the terminal equipment fails to report the failed beams to the network device; or if at least part of input beams of the AI/ML functionality/model for beam management fails, the terminal equipment reports the failed beams to the network device.

In some embodiments, if all output beams of an AI/ML functionality/model for beam management fail, the AI/ML functionality/model for beam management is stopped.

In some embodiments, if all output beams of an AI/ML functionality/model for beam management fail, the AI/ML functionality/model for beam management continues to operate.

In some embodiments, if at least part of output beams of an AI/ML functionality/model for beam management fails, the terminal equipment fails to report the failed beams to the network device.

In some embodiments, if at least part of output beams of an AI/ML functionality/model for beam management fails, the terminal equipment reports the failed beam to the network device.

In some embodiments, if a beam failure occurs but quality of a failed beam predicted based on an AI/ML functionality/model is still above a threshold, the beam failure is not declared (or not determined).

In some embodiments, if a beam failure occurs but quality of a failed beam predicted based on an AI/ML functionality/model is still above a threshold, the beam failure is declared (or determined).

In some embodiments, whether or not a beam failure is declared (or determined) is determined according to a recent event.

In some embodiments, if a candidate beam is determined based on an AI/ML functionality/model for beam management but the candidate beam fails, a terminal equipment falls back to determination of a candidate beam for beam failure recovery without using AI/ML.

In some embodiments, if a beam failure occurs, an AI/ML functionality/model for beam management is deactivated, and if a beam failure is recovered, the AI/ML functionality/model for beam management is activated or re-activated.

In some embodiments, if a beam failure occurs, a first (generalized or default) AI/ML functionality/model for beam management is used, and if a beam failure is recovered, a second (local) AI/ML functionality/model for beam management is used.

In some embodiments, control of an AI/ML functionality/model for beam management is independent of beam failure recovery.

In some embodiments, if a beam failure occurs, performance monitoring of an AI/ML functionality/model for beam management is restarted.

In some embodiments, if a beam failure is recovered, performance monitoring of an AI/ML functionality/model for beam management is restarted.

In some embodiments, if a beam failure occurs, performance monitoring of an AI/ML functionality/model for beam management is paused, and if a beam failure is recovered, performance monitoring of an AI/ML functionality/model for beam management is resumed.

In some embodiments, if a beam failure occurs, performance monitoring of an AI/ML functionality/model for beam management is stopped, and if a beam failure is recovered, performance monitoring of an AI/ML functionality/model for beam management is restarted.

In some embodiments, performance monitoring of an AI/ML functionality/model for beam management is independent of beam failure recovery.

The above embodiments only illustrate the present disclosure. However, the present disclosure is not limited thereto, and appropriate variants may be made on the basis of the above embodiments. For example, the above embodiments may be used alone, or one or more of the above embodiments may be combined together.

It should be noted that the components or modules related to the present disclosure are only described above, however, the present disclosure is not limited thereto. The apparatus 700 for beam management may also include other components or modules. Reference may be made to the related arts for specific content of these components or modules.

In addition, for the sake of simplicity, the FIG. 7 only exemplifies a connection relationship or a signal direction of components or modules, however, those skilled in the art should appreciate that the related arts such as bus connections may be adopted. The components or modules may be implemented by hardware facilities, such as a processor, a memory, a transmitter, and a receiver, which is not limited in the present disclosure.

As can be seen from the above embodiments, the terminal equipment determines the candidate beam for beam failure recovery based on the AI/ML functionality/model, and the AI/ML is able to be used for new candidate beam identification for beam failure recovery, therefore, accuracy and reliability of the beam failure recovery are improved.

### Embodiments of a Fourth Aspect

Embodiments of the present disclosure provide a beam management configuration apparatus, which may be, for example, a network device, or may be one or more components or assemblies configured in the network device, and the same contents to those of the embodiments of the first to third aspects will not be described again.

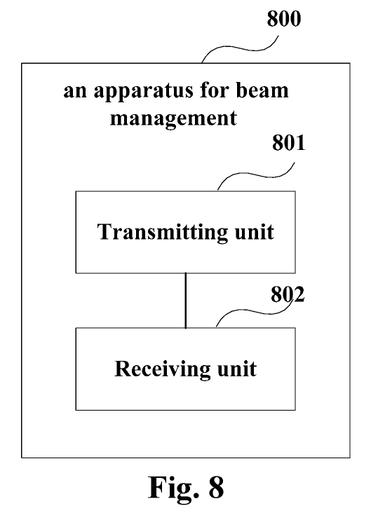

FIG. 8 is another schematic diagram illustrating the apparatus for beam management according to embodiments of the present disclosure. As illustrated in the FIG. 8, an apparatus 800 for beam management includes:
a transmitting unit 801 configured to transmit beam management configuration information and/or beam failure recovery configuration information to a terminal equipment, wherein the terminal equipment determines a candidate beam for beam failure recovery based on an AI/ML functionality/model.

In some embodiments, as illustrated in the FIG. 8, the apparatus 800 for beam management may further include:
a receiving unit 802 configured to receive beam failure recovery information transmitted by the terminal equipment.

The above embodiments only illustrate the present disclosure. However, the present disclosure is not limited thereto, and appropriate variants may be made on the basis of the above embodiments. For example, the above embodiments may be used alone, or one or more of the above embodiments may be combined together.

It should be noted that the components or modules related to the present disclosure are only described above, however, the present disclosure is not limited thereto. The apparatus 800 for beam management may also include other components or modules. Reference may be made to the related arts for specific content of these components or modules.

In addition, for the sake of simplicity, the FIG. 8 only exemplifies a connection relationship or a signal direction of components or modules, however, those skilled in the art should appreciate that the related arts such as bus connections may be adopted. The components or modules may be implemented by hardware facilities, such as a processor, a memory, a transmitter, and a receiver, which is not limited in the present disclosure.

As can be seen from the above embodiments, the terminal equipment determines the candidate beam for beam failure recovery based on the AI/ML functionality/model, and the AI/ML is able to be used for new candidate beam identification for beam failure recovery, therefore, accuracy and reliability of the beam failure recovery are improved.

### Embodiments of a Fifth Aspect

Embodiments of the present disclosure also provide a communication system. Reference may be made to the FIG. 1. The same contents as those of the embodiments of the first to fourth aspects will not be described again.

In some embodiments, a communication system 100 may at least include:
a network device configured to transmit beam management configuration information and/or beam failure recovery configuration information to a terminal equipment; and
the terminal equipment configured to determine a candidate beam for beam failure recovery based on an AI/ML functionality/model.

An embodiment of the present disclosure also provides a terminal equipment, however, the present disclosure is not limited thereto, and other devices may also be involved.

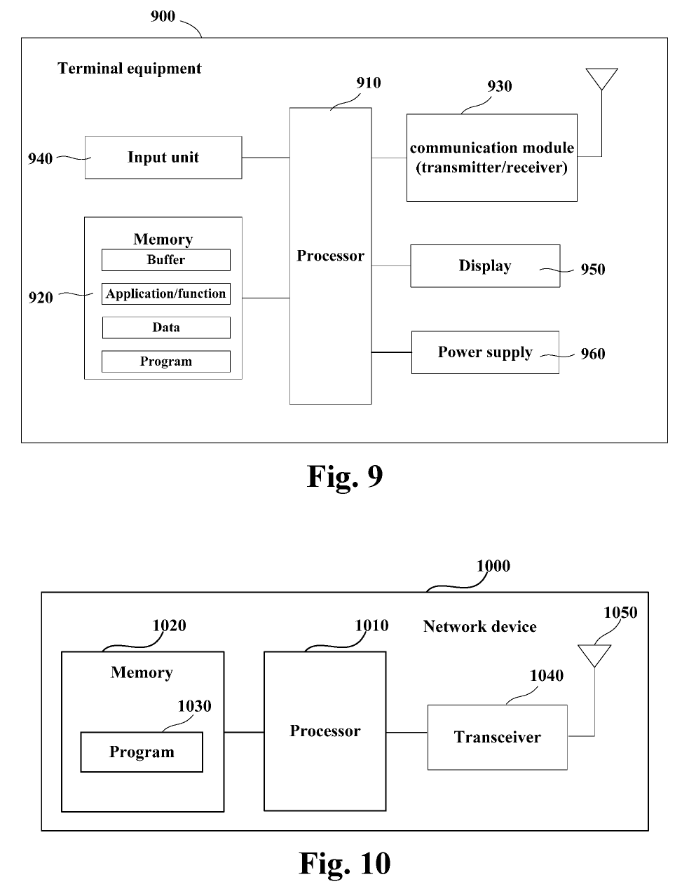

FIG. 9 is a schematic diagram illustrating a terminal equipment according to an embodiment of the present disclosure. As illustrated in the FIG. 9, a terminal equipment 900 may include a processor 910 and a memory 920 that stores data and a program and is coupled to the processor 910. It should be noted that the figure is exemplary; and other types of structures may also be used to supplement or replace this structure, in order to implement telecommunication functions or other functions.

For example, the processor 910 may be configured to execute a program to implement the method for beam management according to the embodiments of the first aspect. For example, the processor 910 may be configured to receive beam management configuration information and/or beam failure recovery configuration information from a network device; and determine a candidate beam for beam failure recovery based on an AI/ML functionality/model.

As illustrated in the FIG. 9, the terminal equipment 900 may further include: a communication module 930, an input unit 940, a display 950, and a power supply 960, wherein functions of the above components are similar to those in the relevant art and will not be described herein again. It should be noted that the terminal equipment 900 does not necessarily include all the components illustrated in the FIG. 9, and the above components are not necessarily required. In addition, the terminal equipment 900 may also include components not illustrated in the FIG. 9. Reference may be made to the relevant art.

An embodiment of the present disclosure further provides a network device, which may be, for example, a base station, however, the present disclosure is not limited thereto, and other network devices may also be involved.

FIG. 10 is a schematic diagram illustrating a composition of a network device according to embodiments of the present disclosure. As illustrated in the FIG. 10, a network device 1000 may include: a processor 1010 (such as a central processing unit (CPU)) and a memory 1020 coupled to the processor 1010. The memory 1020 may store various data. In addition, the memory 1020 may store a program 1030 for information processing, and the program 1030 may be executed under the control of the processor 1010.

For example, the processor 1010 may be configured to execute a program to implement the method for beam management according to the embodiments of the second aspect. For example, the processor 1010 may be configured to transmit beam management configuration information and/or beam failure recovery configuration information to a terminal equipment, wherein the terminal equipment determines a candidate beam for beam failure recovery based on an AI/ML functionality/model.

In addition, as illustrated in the FIG. 10, the network device 1000 may further include: a transceiver 1040 and an antenna 1050, wherein functions of the above components are similar to those in the relevant art and will not be described herein again. It should be noted that the network device 1000 does not necessarily include all the components illustrated in the FIG. 10. In addition, the network device 1000 may also include components not illustrated in the FIG. 10. Reference may be made to the relevant art.

An embodiment of the present disclosure also provides a computer program, wherein when the program is executed in a terminal equipment, the program enables the terminal equipment to perform the method for beam management according to the embodiments of the first aspect.

An embodiment of the present disclosure also provides a storage medium storing a computer program, wherein the computer program enables a terminal equipment to perform the method for beam management according to the embodiments of the first aspect.

An embodiment of the present disclosure also provides a computer program, wherein when the program is executed in a network device, the program enables the network device to perform the method for beam management according to the embodiments of the second aspect.

An embodiment of the present disclosure also provides a storage medium storing a computer program, wherein the computer program enables a network device to perform the method for beam management according to the embodiments of the second aspect.

The above apparatus and method of the present disclosure may be implemented by hardware, or by hardware in combination with software. The present disclosure relates to such a computer-readable program that when the program is executed by a logic device, the logic device is enabled to carry out the apparatus or components as described above, or to carry out the methods or steps as described above. The present disclosure also relates to a storage medium for storing the above program, such as a hard disk, a magnetic disk, a CD, a DVD, a flash memory, etc.

The method/apparatus described with reference to the embodiments of the present disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. These software modules may respectively correspond to the steps shown in the drawings. And these hardware modules, for example, may be carried out by firming these software modules by using a field programmable gate array (FPGA).

The software modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information to the memory medium; or the memory medium may be a component of the processor. The processor and the memory medium may be located in an ASIC. The software modules may be stored in a memory of a mobile terminal and may also be stored in a memory card of a pluggable mobile terminal. For example, if equipment (such as a mobile terminal) employs an MEGA-SIM card of a relatively large capacity or a flash memory device of a large capacity, the software modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in the present disclosure. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

The present disclosure is described above with reference to particular embodiments. However, it should be understood by those skilled in the art that such descriptions are illustrative, and not intended to limit the protection scope of the present disclosure. Various variants and amendments to the present disclosure may be made by those skilled in the art according to the principle of the present disclosure, and such variants and amendments also fall within the scope of the present disclosure.

As to implementations containing the above embodiments, supplements are further disclosed below:

1. A method for beam management, including:
receiving, by a terminal equipment, beam management configuration information and/or beam failure recovery configuration information from a network device; and
determining, by the terminal equipment, a candidate beam for beam failure recovery based on an AI/ML functionality/model.

2. A method for beam management, including:
transmitting, by a network device, beam management configuration information and/or beam failure recovery configuration information to a terminal equipment;
wherein the terminal equipment determines a candidate beam for beam failure recovery based on an AI/ML functionality/model.

3. A terminal equipment, including: a memory configured to store a computer program and a processor configured to execute the computer program to implement the method for beam management according to supplement 1.

4. A network device, including: a memory configured to store a computer program and a processor configured to execute the computer program to implement the method for beam management according to supplement 2.

1. An apparatus for beam management, comprising:
a receiver configured to receive beam management configuration information and/or beam failure recovery configuration information from a network device; and
processor circuitry configured to determine a candidate beam for beam failure recovery based on an AI/ML functionality/model.

2. The apparatus according to claim 1, wherein one or more reference signals are used for measurement and a measurement result is input into the AI/ML functionality/model, and another one or more reference signals are used for output of the AI/ML functionality/model for inference.

3. The apparatus according to claim 2, wherein the candidate beam for beam failure recovery is selected from a prediction result output by the AI/ML functionality/model; and
an AI/ML functionality/model for determining the candidate beam is the same as an AI/ML functionality/model for beam management, or an AI/ML functionality/model for determining the candidate beam is different from an AI/ML functionality/model for beam management.

4. The apparatus according to claim 2, wherein the one or more reference signals for measurement and the one or more reference signals for inference are configured for a terminal equipment;
the one or more reference signals for measurement are the same as reference signals in a second reference signal set for beam management, or the one or more reference signals for measurement are different from reference signals in a second reference signal set for beam management, or the one or more reference signals for measurement are partially the same as reference signals in a second reference signal set for beam management, or the one or more reference signals for measurement are a subset of a second reference signal set for beam management; and
the one or more reference signals for inference are the same as reference signals in a first reference signal set for beam management, or the one or more reference signals for inference are different from reference signals in a first reference signal set for beam management, or the one or more reference signals for inference are partially the same as reference signals in a first reference signal set for beam management, or the one or more reference signals for inference are a subset of a first reference signal set for beam management.

5. The apparatus according to claim 2, wherein a terminal equipment is configured with a candidate beam reference signal list for beam failure recovery, or a terminal equipment is not configured with a candidate beam reference signal list for beam failure recovery.

6. The apparatus according to claim 2, wherein a terminal equipment is configured with a candidate beam reference signal list for beam failure recovery, a measurement result of the candidate beam reference signal list is input into the AI/ML functionality/model, and one or more beams in a prediction result output by the AI/ML functionality/model are selected as candidate beam(s) for beam failure recovery; and
reference signals in the candidate beam reference signal list are the same as reference signals in a second reference signal set for beam management, or reference signals in the candidate beam reference signal list are different from reference signals in a second reference signal set for beam management, or reference signals in the candidate beam reference signal list are partially the same as reference signals in a second reference signal set for beam management, or reference signals in the candidate beam reference signal list are a subset of a second reference signal set for beam management.

7. The apparatus according to claim 2, wherein a terminal equipment is configured with a candidate beam reference signal list for beam failure recovery, a measurement result of the candidate beam reference signal list is used for inference of the AI/ML functionality/model, and one or more beams in a prediction result output by the AI/ML functionality/model are selected as candidate beam(s) for beam failure recovery; and
reference signals in the candidate beam reference signal list are the same as reference signals in a first reference signal set for beam management, or reference signals in the candidate beam reference signal list are different from reference signals in a first reference signal set for beam management, or reference signals in the candidate beam reference signal list are partially the same as reference signals in a first reference signal set for beam management, or reference signals in the candidate beam reference signal list are a subset of a first reference signal set for beam management.

8. The apparatus according to claim 1, wherein the apparatus further comprises:
a transmitter configured to transmit beam failure recovery information to the network device via at least one of a MAC-CE (media access control-control element), a dedicated PRACH (physical random access channel), or a contention-based PRACH.

9. The apparatus according to claim 1, wherein a spatial beam prediction and/or a temporal beam prediction is/are applied to determination of a candidate beam for beam failure recovery.

10. The apparatus according to claim 1, wherein the AI/ML functionality/model is further used to predict a beam failure event, wherein L1-RSRP (Reference Signal Received Power)/L1-SINR (Signal-to-Interference-plus-Noise Ratio) or hypothetical BLER (Block Error Rate) of one or more reference signals is input into the AI/ML functionality/model.

11. The apparatus according to claim 1, wherein if all input beams of an AI/ML functionality/model for beam management fail, the AI/ML functionality/model for beam management is stopped, or if all input beams of an AI/ML functionality/model for beam management fail, the AI/ML functionality/model for beam management continues to operate; or
if part of input beams of an AI/ML functionality/model for beam management fails, the failed beams are not input to the AI/ML functionality/model for beam management; or if part of input beams of an AI/ML functionality/model for beam management fails, the failed beams are still input to the AI/ML functionality/model for beam management.

12. The apparatus according to claim 1, wherein an AI/ML functionality/model for beam management is located at a network device side;
if at least part of input beams of the AI/ML functionality/model for beam management fails, a terminal equipment does not report the failed beams to the network device; or if at least part of input beams of the AI/ML functionality/model for beam management fails, the terminal equipment reports the failed beams to the network device.

13. The apparatus according to claim 1, wherein if all output beams of an AI/ML functionality/model for beam management fail, the AI/ML functionality/model for beam management is stopped, or if all output beams of an AI/ML functionality/model for beam management fail, the AI/ML functionality/model for beam management continues to operate.

14. The apparatus according to claim 1, wherein if at least part of output beams of an AI/ML functionality/model for beam management fails, a terminal equipment does not report the failed beams to the network device; or if at least part of output beams of the AI/ML functionality/model for beam management fails, the terminal equipment reports the failed beams to the network device.

15. The apparatus according to claim 1, wherein if a beam failure occurs but quality of a failed beam predicted based on an AI/ML functionality/model is still above a threshold, the beam failure is not declared; or if a beam failure occurs but quality of a failed beam predicted based on an AI/ML functionality/model is still above a threshold, the beam failure is declared; or
whether or not a beam failure is declared is determined according to a recent event.

16. The apparatus according to claim 1, wherein if a candidate beam is determined based on an AI/ML functionality/model for beam management but the candidate beam fails, a terminal equipment falls back to determination of a candidate beam for beam failure recovery without using AI/ML.

17. The apparatus according to claim 1, wherein if a beam failure occurs, an AI/ML functionality/model for beam management is deactivated, and if a beam failure is recovered, an AI/ML functionality/model for beam management is activated or re-activated; or
if a beam failure occurs, a first AI/ML functionality/model for beam management is used, and if a beam failure is recovered, a second AI/ML functionality/model for beam management is used; or
control of an AI/ML functionality/model for beam management is independent of beam failure recovery.

18. The apparatus according to claim 1, wherein if a beam failure occurs, performance monitoring of an AI/ML functionality/model for beam management is restarted, or if a beam failure is recovered, performance monitoring of an AI/ML functionality/model for beam management is restarted; or
if a beam failure occurs, performance monitoring of an AI/ML functionality/model for beam management is paused, and if a beam failure is recovered, performance monitoring of an AI/ML functionality/model for beam management is resumed; or
if a beam failure occurs, performance monitoring of an AI/ML functionality/model for beam management is stopped, and if a beam failure is recovered, performance monitoring of an AI/ML functionality/model for beam management is restarted; or
performance monitoring of an AI/ML functionality/model for beam management is independent of beam failure recovery.

19. An apparatus for beam management, comprising:
a transmitter configured to transmit beam management configuration information and/or beam failure recovery configuration information to a terminal equipment;
wherein the terminal equipment determines a candidate beam for beam failure recovery based on an AI/ML functionality/model.

20. A communication system, comprising:
a network device configured to transmit beam management configuration information and/or beam failure recovery configuration information to a terminal equipment; and
the terminal equipment configured to determine a candidate beam for beam failure recovery based on an AI/ML functionality/model.
